(19) United States
(12) Patent Application Publication
(10) Pub. No.: US 2005/0140821 A1
(43) Pub. Date: Jun. 30, 2005

(54) Light source used for light-sensing devices

(76) Inventor: James D. Hammond, Hsin-Chu (TW)

Correspondence Address: PERKINS COIE LLP;PATENT-SEA, P.O. BOX 1247, SEATTLE, WA, 98111-1247, US

(21) Appl. No.: 10/748,983

(22) Filed: Dec. 30, 2003

(51) Int. Cl. H04N 5/222

(52) U.S. Cl. 348/370; 348/371

(57) ABSTRACT

A light source is employed for an image capturing apparatus and a light-sensing device of the image capturing apparatus respectively senses a plurality of color regions to form an image captured. The light source comprises a lighting source and a light-guiding means, and the light-guiding means guides a light from the light source to an object to capture an image. An intensity of one color region of the color regions of the light from the light source is higher than that of other color regions.

### TECHNICAL FIELD

This invention relates to a light source, and more particularly to a light source used for light-sensing devices.

### BACKGROUND

Recently, the main light-sensing devices comprise electronic image sensors, i.e.: charge coupled device (CCD) and complementary metal-oxide semiconductor (CMOS), and films. The electronic image sensor functions as a converter that converts a light signal into an analog signal. For example, the CMOS sensor comprises a photodiode generating electric charges proportional to an incident light. When the electric charges integrated by a pixel capacitor are transmitted to a gain amplifier and an A/D converter, an original signal of a captured image is formed. The image sensor must have the aforementioned functions.

RGB filters are generally employed for capturing a color image. The electronic image sensor senses different colors through the RGB filters, and the different colors are combined to form a color image. Referring to FIG. 1, a pixel matrix 10 has four electric light-sensing devices 12 and the corresponding RGB color filters R, G, and B. The common arrangement of the color filters is RGGB, i.e. the color ratio is R:G:B=25%:50%:25%. Such a ratio is due to the human visual system that the green sensitivity thereof is higher, so the combined color by such arrangement is close to a color sensed by the human visual system. In addition to the aforementioned arrangement, other arrangement of color filters and pixel matrixes are also developed, e.g. RGBE (red, green, blue, and emerald) arrangement developed by Sony, pixel matrix arrangement of SuperCCD (octangle shape) developed by FujiFilm and so on.

These electric light-sensing devices, such as CCD, CMOS, and so on, have different sensitivities for different colors of an incident light. Thus, each color of a captured image can not be balanced. The method for solving unbalanced color sensitivity is to apply color division gain or amplifying technology to achieve the correct white balance. Namely, in accordance with the different color sensitivities of the electric light-sensing device, different gains are applied and so the resulting color is close to the actual color (or the color eyes sensing). In general, the sensitivity of the present CCD and CMOS in blue is weaker than that in red and green; hence the gain value of blue must be higher than that of red and green. However, the method of adjusting gain value generates problems of high S/N ratio, low color stereo, and even color shift. The cause thereof is described below.

Under the situation with enough illumination, the image captured by these electric light-sensing devices can be appropriately corrected to be close to the actual color (or the color eyes sensing). This is due to strong enough light signal, the electric light-sensing device can resolve the light into enough brightness levels of colors and the gain values can be corrected without affecting the white balance.

However, under the situation without enough illumination (low light), the inherent characteristic of various color sensitivity becomes an inherent drawback. In general, a true color image has each 256 brightness levels in red, green, and blue, respectively. Under the situation with enough illumination, the electric light-sensing device can obtain enough signals to easily resolve the captured image into 256 brightness levels in the respective colors. Nevertheless, under a low light situation, for example, the red and green lights can be resolved into 50 brightness levels and the blue can be resolved only into 10 brightness levels due to the blue sensitivity of CCD and CMOS is weaker than that of red and green. Under low light situations, a flash is generally used to provide enough illumination for a subject. Although, the electric light-sensing device can resolve 256 brightness levels in red and green with the flash under low light situations, the electric light-sensing device still can not obtain enough blue color signal and can not resolve blue light into 256 brightness levels. This will result in an image without a correct color and generate color shift, even the captured image may lack stereo. For example, a color with R: 100, G: 100, and B: 100 is a gray; nevertheless, the electric light-sensing device only resolve 25 brightness levels in blue. The blue values will be adjusted into 5, 15, 25 . . . , and 245. Thus, the color only can be indicated with R: 100, G: 100, B: 95 or R: 100, G: 100, B: 105, so the color shift is produced.

Moreover, the image does not have enough amount of brightness levels in blue, so the image is not a true color image and not lively. Furthermore, the blue sensitivity is lower, so the gains of red and green must be reduced for matching with the blue, that results in a higher S/N ratio and affects the image quality.

### SUMMARY

In those conventional arts, the electric light-sensing device has some drawbacks under the low light situation. One of objectives of the present invention is to provide a light source for providing optimized light under the low light situation. Therefore, the captured image has enough brightness levels in respective colors to increase the image quality.

Another objective of present invention is to provide an assistant light source under the situation with enough illumination to increase brightness in colors for obtaining a vivid image.

Still objective of present invention is to provide a light source to balance the color gain values for the electric light-sensing device to avoid generating a high S/N ratio due to a color gain value being too high.

As aforementioned, the present invention provides a blue light source used for a light-sensing device. The blue light source comprises a lighting source and a light-guiding means. The lighting source has three color regions of red, green and blue and the light-guiding means guides a light from the lighting source to an object to capture an reflected image. After the light passes the light-guiding means, an intensity of the blue region of the light is higher than that of the red and green regions.

The present invention also provides a light source used for an image capturing apparatus, and a light-sensing device of the image capturing apparatus respectively senses a plurality of color regions to form an image captured. The light source comprises a lighting source and a light-guiding means. The light-guiding means guides a light from the lighting source to an object to capture an image. After the light passes the light-guiding means, an intensity of one color region of the light is higher than that of other color regions.

Hence, compared with the conventional arts that have the problems of the image color balance and the captured image without enough color brightness level due to a sensing capability of a light-sensing device in one color is weaker than that in other colors. The present invention may aim at the color that is the weaker sensing capability of the light-sensing device to provide a light source. Therefore, the light-sensing device can sense proper signals of the respective color and the captured image is lively and has the actual color.

### BRIEF DESCRIPTION OF THE DRAWINGS

FIG. 1 is a schematic diagram of an electronic image sensor in the conventional arts;

FIG. 2A is a schematic diagram of a light source of one preferred embodiment in the present invention;

FIG. 2B is a schematic diagram of a light source of another preferred embodiment in the present invention; and

FIG. 3 is a frequency spectrum of a light source in the present invention.

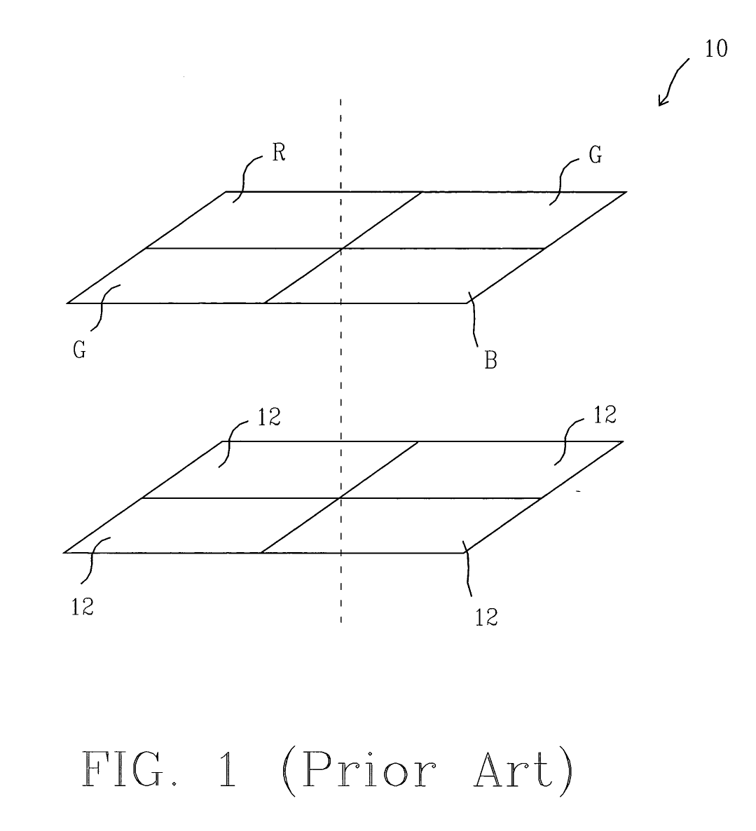

### DETAILED DESCRIPTION

Some sample embodiments of the invention will now be described in greater detail. Nevertheless, it should be recognized that present invention can be practiced in a wide range of other embodiments besides those explicitly described, and the scope of the present invention is expressly not limited expect as specified in the accompanying claims.

Then, the components of the different elements are not shown to scale. Some dimensions of the related components are exaggerated and meaningless portions are not drawn to provide a more clear description and comprehension of the present invention.

A light-sensing device in the conventional arts not only comprises film, but also comprises CCD and CMOS that is substantially applied to digital camera recently. These light-sensing devices simulate retinas to sense the primary colors of red, green, and blue for forming a captured image close to the image eyes sensing. Nevertheless, these light-sensing devices have inherent physical limitation that a sensing capability of the light-sensing devices for one primary color is weaker than that for other primary colors. For example, the blue sensing capability of CCD and CMOS is weaker than other color sensing capabilities. In addition, Color sensing capabilities of films is determined according to respective sensing sequence of color sensing layers, and the red or blue sensing capabilities of the films is generally weaker.

Hence, the present invention discloses a blue light source used for a light-sensing device. The blue light source comprises a lighting source and a light-guiding means. The lighting source has three color regions of red, green and blue, and the light-guiding means guides a light from the lighting source to an object to capture an image. After the light passes the light-guiding means, an intensity of the blue region of the light is higher than that of the red and green regions. Hence, the light source of the present invention can increase the intensity of the blue region and the light-sensing device can receives a higher intensity of the blue region for overcoming the inherent drawback of the light-sensing device.

As aforementioned, the light-sensing device may have a weaker sensing capability for another color that is not blue. Hence, the present invention also discloses a light source used for an image capturing apparatus. A light-sensing device of the image capturing apparatus respectively senses a plurality of color regions to form an captured image and a color sensing capability of the light-sensing device for one color region is weaker than that for other color regions. The light source comprises a lighting source and a light-guiding means. The light-guiding means guides a light from the lighting source to an object to capture an image. After the light passes the light-guiding means, an intensity of the color region of the light is higher than that of other color regions. The plurality of color regions may be three color regions of RGB, four color regions of RGBE, the complementary colors of CMYG, or other color division.

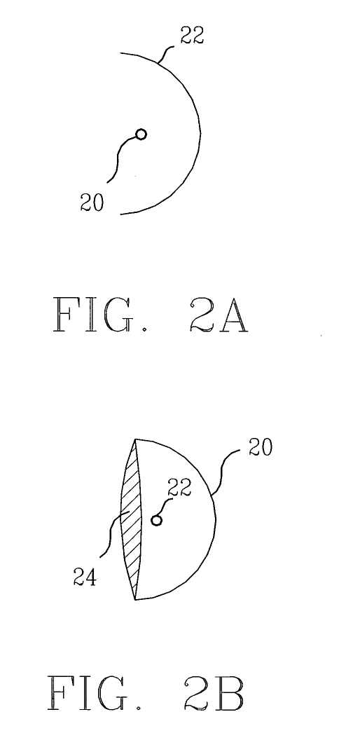

Referring to FIG. 2A, it is a structure of a light source of one preferred embodiment in the present invention. The light source comprises a lighting source 20 and a light-guiding means. The light-guiding means is a concave mirror 22 herein. The concave mirror 22 not only guides a light from the lighting source 20 to an object to capture an image, but condenses the light from the lighting source 20 for strengthening the illumination to a subject. After the light from the lighting source 20 passes the light-guiding means, an intensity of one color region of the light is higher than that of other color regions. The light-sensing device can receive a higher intensity of the color region for getting over the inherent drawback of the light-sensing device.

Moreover, the aforementioned light-guiding means may further comprise a lens series 24. FIG. 2B is another preferred embodiment in the present invention. The lens series 24 may be employed to adjust the condenseness of the light for matching the desired illuminating range. For example, a zooming range of a camera is various according to a focal length of a zoom lens of the camera, thus the most light from the lighting source 20 can be adjusted to match the capturing range by the lens series 24. Furthermore, the lens series 24 may enhance the condensing effect of the concave mirror 22 for forming a uniform light in the capturing range. The lens series may have a polarizing effect or other effects to increase the application range of the present invention.

One essence of the present invention is to provide a light source for getting over the weaker sensing capability of a light-sensing device for a color, which an intensity of the color region thereof is higher than that of other color regions. Therefore, as shown in FIG. 2A and FIG. 2B, the desired color light can be generated by the light illuminated from the lighting source passing the concave mirror 22 with the color. Alternative, the desired color light can be generated by the light illuminated from the lighting source passing the lens series 24 with the color. The desired color light is also directly generated by the lighting source 20, and the concave mirror 22 or the lens series 24 does not have a function of adjusting color. The lighting source 20 illuminating the desired color light can be formed by a luminary and a color filter, or luminaries (i.e. LED) luminescing the desired color light without filters. If the lighting source 20 comprises a filter, the filter may be a polarizing filter. Moreover, the light source of the present invention not only overcomes the drawback of color sensing capability of the light-sensing device, but also enhances some particular effects. For example, the captured image can be red shift by a red flash to obtain a different vision effect.

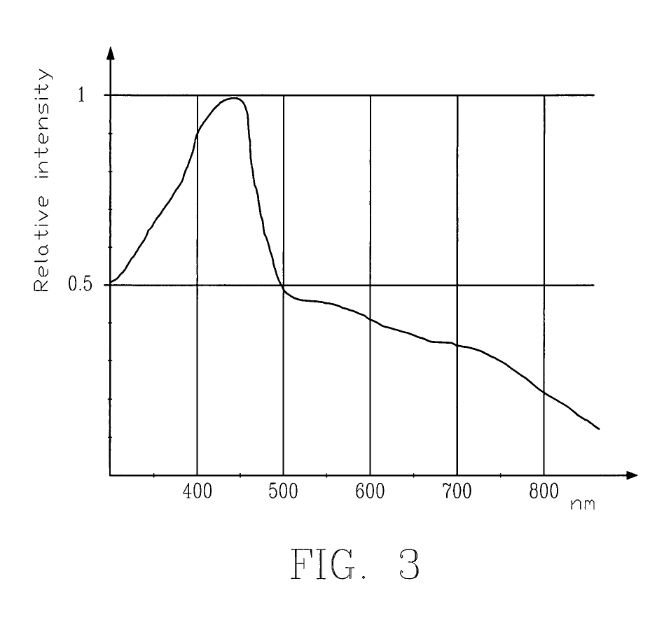

If the light-sensing device is a CCD or a CMOS, an intensity of the blue region of the light source in the present invention may be higher than that of other regions. A wavelength region of the blue region is preferably 390 nm to 500 nm, more preferably 450 nm to 500 nm. The average intensity of the color region is preferably 100% higher than the average intensity of other color regions, as shown in FIG. 3.

Apparatuses using film, CCD, CMOS, or other light-sensing device are quite a few, i.e. camera, video camera, scanner, color photostat, color fax, digital camera, digital video camera, web camera, and so on. The present invention can apply to any light-sensing device that one color (frequency range) sensing capability is weaker than other color (frequency range) sensing capability. For example, the light source of the present invention is a flash and turns on for increasing the illumination for a subject when the ambient light is low light. The flash may be mounted on a camera or outside of a camera (i.e. a studio strobe). In addition, the light source of the present invention may be used under the situation with enough illumination for increasing the effect in color of the captured image (i.e. more white at sand beach).

The light source of the present invention may be a light with a short period, such as a flash. The light source is also a continuous light for applying to an apparatus needing a continuous light, such as video camera, scanner, color photostat, and so on.

Furthermore, digital image capturing apparatuses (i.e. digital video camera, digital camera) have some white balance mode of sunlight, cloudy, shade, incandescent, fluorescent, etc. Namely, due to the human visual system will regulate to adapt to an environmental color temperature. Therefore, under different environmental color temperatures, the human visual system can determine that the color of a white paper is white. For instance, a person enters a room illuminated by a tungsten lamp and senses that the light is yellow initially. The photoreceptor cells of retinas gradually tire with yellow and then sense that the light is white. However, the light-sensing device still fairly recording the color without the tiring problem of the human visual system and the captured image is different from that the human visual system senses. Hence, the digital image capturing apparatus correct the color of the captured image to be close to that the human visual system senses through the white balance process. When the light source of the present invention is applied to a digital image capturing apparatus, the white balance modes of the digital image capturing apparatus can add a flash mode to correct the color of the captured image. The flash mode may turn on automatically or manually.

Although specific embodiments have been illustrated and described, it will be obvious to those skilled in the art that various modifications may be made without departing from what is intended to be limited solely by the appended claims.

1. A light source used for an image capturing apparatus and a light-sensing device of said image capturing apparatus respectively senses a plurality of color regions, said light source comprising:
a lighting source; and
means for guiding a light from said lighting source to an object to capture an image, wherein after said light pass said light-guiding means, an intensity of one color region of said light is higher than that of other color regions.

2. The light source in claim 1, wherein a sensing capability of said light-sensing device in said color region is weaker than that in said other color regions.

3. The light source in claim 2, wherein said color region is a blue region.

4. The light source in claim 3, wherein a wavelength range of said blue region is 390 nm to 500 nm.

5. The light source in claim 1, wherein said lighting source is composed of a luminary and a blue filter.

6. The light source in claim 5, wherein said blue filter is a polarizing filter.

7. The light source in claim 1, wherein said lighting source is LEDs.

8. The light source in claim 1, wherein said light-guiding means comprises a concave mirror.

9. The light source in claim 8, wherein said concave mirror is a concave mirror with a color of said color region.

10. The light source in claim 8, wherein said light-guiding means further comprises a lens series.

11. The light source in claim 10, wherein said lens series is a lens series with a color of said color region.

12. The light source in claim 1, wherein said light-sensing device is selected form the group consisting of film, CCD, and CMOS.

13. The light source in claim 1, wherein said image capturing apparatus is a CMOS digital camera.

14. A blue light source used for a light-sensing device, comprising:
a lighting source having three color regions of red, green and blue; and
means for guiding a light from said lighting source to an object to capture an image, wherein after said light pass said light-guiding means, an intensity of said blue region of said light is higher than that of said red and green regions.

15. The blue light source in claim 14, wherein said lighting source is composed of a luminary and a blue filter.

16. The blue light source in claim 15, wherein said blue filter is a polarizing filter.

17. The blue light source in claim 14, wherein said lighting source is LEDs.

18. The blue light source in claim 14, wherein a wavelength range of said blue region is 390 nm to 500 nm.

19. The blue light source in claim 14, wherein said lighting source is mounted on a camera.

20. The blue light source in claim 14, wherein said light-guiding means comprises a concave mirror.

21. The blue light source in claim 20, wherein said concave mirror is a blue concave mirror.

22. The blue light source in claim 20, wherein said light-guiding means further comprises a lens series.

23. The blue light source in claim 22, wherein said lens series is a blue lens series.

24. The blue light source in claim 14, wherein said light-sensing device is selected form the group consisting of film, CCD, and CMOS.1.
